(19) United States
(12) Patent Application Publication
(10) Pub. No.: US 2002/0029226 A1
(43) Pub. Date: Mar. 7, 2002

(54) Method for combining data with maps

(76) Inventors: Gang Li, Castro Valley, CA (US); Xiaoming Zheng, Albany, CA (US); Kenneth Leonard, Hillsborough, CA (US)

Correspondence Address: Thomas M. Freiburger, 25th Fl., 650 California Street, San Francisco, CA, 94108, US

(21) Appl. No.: 09/947,637

(22) Filed: Sep. 5, 2001

Related U.S. Application Data
(60) Provisional application No. 60/229,754, filed on Sep. 5, 2000.

(51) Int. Cl. G06F 17/30

(52) U.S. Cl. 707/104.1; 707/1; 701/208; 707/10

(57) ABSTRACT

A method and system for taking data in any format, either in a database such as Oracle, SQL, or another common database, and dynamically combining it with geographic information, i.e., a map or aerial or satellite photograph or other image, allows the user to display that data on a map, to analyze that data geographically or spatially or merely to provide information from certain locations. The result can be presented to the user as a single image that can, if desired, be interactive, allowing the user to access additional information not displayed or not capable of displaying on the map.

### BACKGROUND OF THE INVENTION

This application claims benefit of provisional application Serial No. 60/229,754 filed Sep. 5, 2000.

The present invention relates generally to an integration system for combining location relevant data and maps or geographic images. More specifically, the invention concerns the combining data with maps via any wired or wireless network and communicating that combined information via any wired or wireless network.

The prior art utilized geographic maps and location relevant data and combined them in a proprietary format. This proprietary format made it difficult for data of other formats (e.g., relational database format) to be graphically displayed and managed based on location in real time or even close to real time. In order to facilitate efficient browsing of data against a geographic backdrop, it is necessary to release the data from a proprietary data-map combination format and be able to take data, in any form, from any database regardless of that database's physical location or data type, and combine it with a graphical map when it is needed.

### SUMMARY OF THE INVENTION

The present invention provides a method and system for taking data in any format, either in a database such as Oracle, SQL, or another common database, and dynamically combining it with geographic information, be it in the form of a map or an aerial or satellite photograph or other image, to allow the client to display that data on a map, to analyze that data geographically or spatially or merely to provide the client information from certain locations. The result can be presented to the user as a single image that can, if desired, be interactive, allowing the user to access additional information not displayed or not capable of displaying on the map.

All embodiments have the benefit of flexibility, speed, and efficiency over the prior art. The release of data from the prior art's proprietary format allows flexibility and speed over the prior art because it permits the parallel processing of data from each concerned database.

One embodiment of the invention includes a central controller, a user database and a map server all stored on local servers, or machines that are located proximal to each other on the same LAN. The user database may contain the locations of all of a client's switching centers around the country for the direction of traffic across a network, or the locations of distribution warehouses or any other data that concern the geographical placement of a client's business elements. The user may also have maps showing the location of each node or each warehouse across the country. This embodiment takes information from the user database and places it on top of the user's maps, if any, or with map data already stored in the system of the invention. The user data and the maps are combined in this layered fashion. The result is then presented either as a single image with icons representing each node, or business element, or as icon layers sitting on top of the map layer without making them into a single image. Either case is referred to as a combined image, and the image looks the same to the user in either event. The combination of textual data with the map information allows the user to better analyze any number of variables such as traffic flow patterns, density of equipment in any given area, distances between significant nodes, most efficient versus least efficient routes, descriptions of facilities at various locations, etc. Additionally, each icon can be a hyperlink that when activated will show the user any or all of the information on that node or warehouse stored in the client's database.

In another embodiment of the system and method, communications between the elements of the system and method can be done across a wired or wireless network of any size including the Internet. An example of this distributed embodiment could use the central controller and four nodes from which to collect the data: a business information database, an advertising database, a geocoding engine, and a map server, all located on servers separated by physical distance but connected by wired network, such as the Internet, or wireless networks. A business information database is a database with records on businesses which can include business name, address, telephone number, product information, a designation of a pre-categorized business type, product pictures and any other conceivable data that can be gathered about a business.

An advertising database contains advertising information which can be textual and graphical elements stored and organized by associating each business with a unique I.D. This I.D. is matched to advertising elements in the advertising database.

A geocoding engine simply takes commonly formatted addresses and converts them into geographic X and Y coordinates.

A map server is more than just a database of street names. A map server contains special software for creating a graphical map based on geographic X and Y coordinates and other related information. The map server can create maps of variable sizes dependent on the radius distance within which a map should be built. This embodiment serves users who are searching for either the location of a specific business or a business of a particular type and the location thereof. A user who wishes to locate a business can access the central controller via a web server, which can be on the same machine as the Central Controller or can be on an independent server, and a browser on their local PC. The user will then be prompted to enter a conditional location request (CLR) containing the address, and/or business name, and/or type of business, and/or distance that the user wants to locate a business within from a user-selected central point. At least one of the above variables must be entered. Because a CLR may have one or more of these options, a CLR can be broken down into more specific requests. These more specific requests are what are actually sent to the individual databases. Upon receiving a CLR, the Central Controller breaks it into more specific CLRs each containing a more specific request within the user's original CLR. These more specific CLRs are then sent to the three previously mentioned databases.

The fourth node, the geocoding engine mentioned above, does not contain any data that a user would search for. Any address entered by a user in his CLR, including an address to use as the central point from which the radius of the search will be determined, will be passed to the geocoding engine which will assign numeric geographic X and Y coordinate values to the entered address. Therefore, following a user's request in this embodiment, the request goes from the user's PC to the web server. The request then proceeds to the central controller of the system of the invention where any address information is sent to the geocoding engine. The geocoding engine returns back to the Data Interpretation and Integration Server (DIIS) X and Y coordinate values that are equivalent to the entered address. The rest of the CLR is sent to the DIIS.

The DIIS is within the central controller and is what actually generates the multiple threads that are fed simultaneously via networks to the three databases. The DIIS next sends the following to the all three databases simultaneously: the X and Y coordinate values received by the geocoding engine, the business name (if provided), the business type (if entered by the user), and the search radius (either entered by the user or the system default of one-half mile). Each database receives all of these elements and is able to process, independently of each other database, its own response. This is the nature of the parallel processing advantage allowed by this invention.

Continuing to trace the logical path of CLR, the business information database is first considered. This database contains the names of businesses, the type of business, each business' unique ID, the addresses of each business, and X and Y coordinate values that match each address of each business. These are not the only values held here, but simply are provided for this example. The database will then attempt to match the data sent by the DIIS with any fields it may hold. For instance, if a user entered a business name, then that name will be searched for and returned if found. If a user entered an address, that address will be searched for. If no address was entered and no business name was entered then all fields with matching business types will be returned and limited by the search radius from the center point. If this radius is one-half mile then all matching business types within one-half mile of the center point will be returned. Any returned data will be layered on top of the map that will be returned by the map server.

Looking next to the advertising database, this database contains advertising information associated with the businesses in the business information database. Not all business necessarily is included. A similar process to the one above follows this database's receipt of its threaded request. The request sent to this database is exactly the same as the one sent to the business information database and the same matching attempts are made. If any hits are made then the appropriate data is sent back to the central controller and layered on top of the map returned by the map server.

Finally, the threaded request is also received by the map server at the same time as the other servers. The software in the map server will take the X and Y coordinates provided by the geocoding engine and match those coordinates to generate a map. The size of the map will be determined by the radius distance. Though the map server receives the same query as the other two servers, the only data that this server is concerned with are the X and Y coordinates of the entered address, if any, and the radius distance.

In another embodiment, a map server stores geographic information such as road maps and city street maps of the Untied States and other information such as parks, hospitals, schools, lakes, railroads, ferry terminals, etc., and corresponding X and Y coordinates for each address. Such a map server could be an off-the-shelf product such as Environmental Systems Research Institute RouteMap IMS, or licensed from other map companies such as MapQuest.com, Inc., MapBlast.com, Inc., or Vicinity, Inc.

The DIIS will receive the responses from each of the above mentioned nodes and layer the returned business information, the advertising information on top of the map image to create a second image that might include all of the above mentioned elements. As mentioned above it is helpful to visualize this process by looking at the completed image from the side, with the map image being the bottom layer and any other data being placed on levels rising from this bottom layer. This result can be presented to users as a multiple image arranged in layers, or as a single image. The single image will also be a standard image format. It is possible here, before the final image is delivered to the user, for software to compile the business map as well as all the data associated with either that map location, that business, or both to create a truly information rich, yet truly geo-targeted business information page.

In another embodiment of the system and method, the central controller and a database are stored on the same computer or on two local computers on the same local area network. They communicate with a remotely located map server over a wired or wireless network of any size. This embodiment benefits the user who does not want to share a database(s) with a map server provider.

In another embodiment of the system and method, the central controller and a MAP database are stored on the same computer or on two local computers on the same local area network. They communicate with remotely located databases over wired or wireless networks of any size. This embodiment benefits the user who installs the central controller and map server on a mobile computing device such as a laptop.

In another embodiment of the system and method, the central controller is a single serving computer or an array of computers. It communicates with databases remotely located over any wired network including the Internet. Users, however, can communicate with the central controller over a wireless network via any wireless device such as a WAP enabled cellular phone or PDA with a wireless modem. The central controller receives the request via the wireless network, collects the data and map, if any, from the remote databases, and returns a result to the user via the wireless network.

It is a principal goal of this invention to provide a robust system that uses graphics to present information over wired or wireless electronic communications systems, with the information combined and presented essentially in real time. The system also facilitates more efficient business decision-making where such decisions necessarily rely on location based information. Further, the invention provides a truly geo-targeted advertising system that can help businesses increase their revenue stream. Because the I.D. of each business can be associated with an unlimited number of records in any number of databases, businesses can use this tool to identify their allies versus their largest competitors in any given geographic area.

### DESCRIPTION OF THE DRAWINGS

FIG. 1 illustrates in a system diagram a first embodiment of the present invention.

FIG. 2 is a block diagram showing one embodiment of the central controller of the system.

FIG. 3 is a block diagram showing one embodiment of a map engine.

FIG. 4 is a block diagram showing one embodiment of a business database.

FIG. 5 is a block diagram showing one embodiment of an advertisement database.

FIG. 6 schematically illustrates in one form how a conditional business location request is generated.

FIG. 7 illustrates how multiple threads are generated to distribute a user request among the map engine, the business database and the advertisement database.

FIG. 8 illustrates a process of base map extraction.

FIG. 9 illustrates a business database.

FIG. 10 illustrates a advertisement database.

FIG. 11 illustrates an integration process for a map image and business icons.

FIGS. 12A and 12B illustrate an example of an online embodiment of business icons being overlaid on a local map, specifically, Japanese restaurants within Jack London Square, Oakland, Calif.

FIG. 13 shows an example of an online embodiment involving business advertisement banners combined with a business map, specifically advertisements of apparel stores in downtown San Francisco, Calif.

FIG. 14 illustrates the distributed nature of the system where the databases to be queried are not proximal to the Central controller.

### DESCRIPTION OF PREFERRED EMBODIMENTS

In one preferred embodiment, the present invention in general includes a user interface, a central controller (CC), a map engine and one or more databases containing location-relevant data that may be combined with a map from the map engine. This embodiment of the invention stores and manages location-relevant data based on their locations and can manage this information using multiple independent databases for fast retrievals. The results of user requests for database data will be displayed using graphic representations on maps. The resulting information-rich map integrating all possible information is generated dynamically and interactively in real time. Thus, a user is able to use his preference of geography to selectively locate data on features and interact with them, all on a map using graphic elements rather than textual menus. In addition to ease of use, a user will get more information by interacting with icons and other hyperlinked elements on a map of this design.

One specific embodiment is useful for consumers seeking to identify and locate certain types of business in a geographical area, optionally with advertising information.

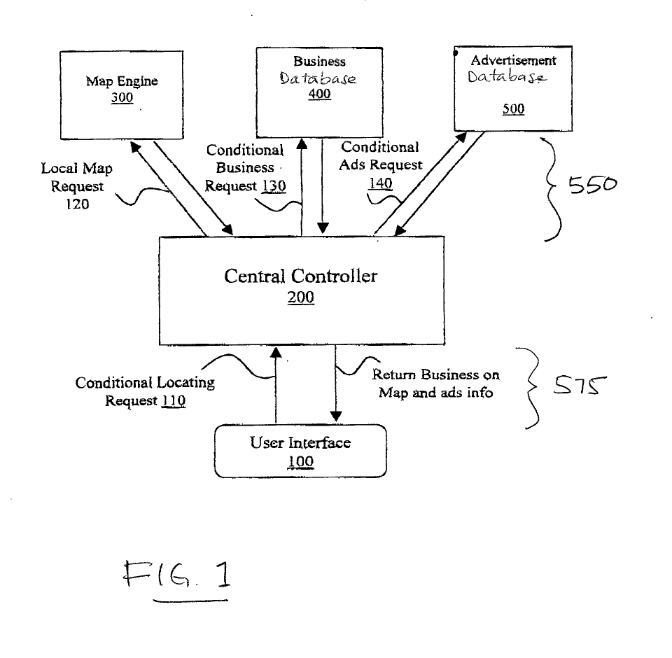

The system architecture of this embodiment of the system is illustrated with reference to FIGS. 1 through 5. As shown in FIG. 1, the apparatus of the present invention comprises a user interface 100, a central controller (CC) 200, a map engine (ME) 300, a business database (BDB) 400, and an advertisement database (ADB) 500. CC 200 is connected to ME 300, BDB 400 and ADB 500 via the Internet, or an intranet, LAN or WAN 550; CC 200 is connected to the user interface 100 via an Internet (or intranet, LAN or wireless) connection 575. These connections may also exist over a cellular, microwave, or satellite network 575. As previously mentioned, however, it is also possible for the ME, BDB and ADB to exist on the same server.

In a modified embodiment, the present invention includes a user interface 100 and a central controller (CC) 200. The central controller communicates with users through user interface 100. Upon receiving user's request, the controller 200 interprets the request and divides it into multiple sub-requests, which will then be sent to, via wired or wireless network, data provider(s) and map provider(s) separately but simultaneously. The data and map providers may be at separate sites. Upon receiving responses from data provider(s) and map provider(s), the central controller combines data and map before sending the result back to user.

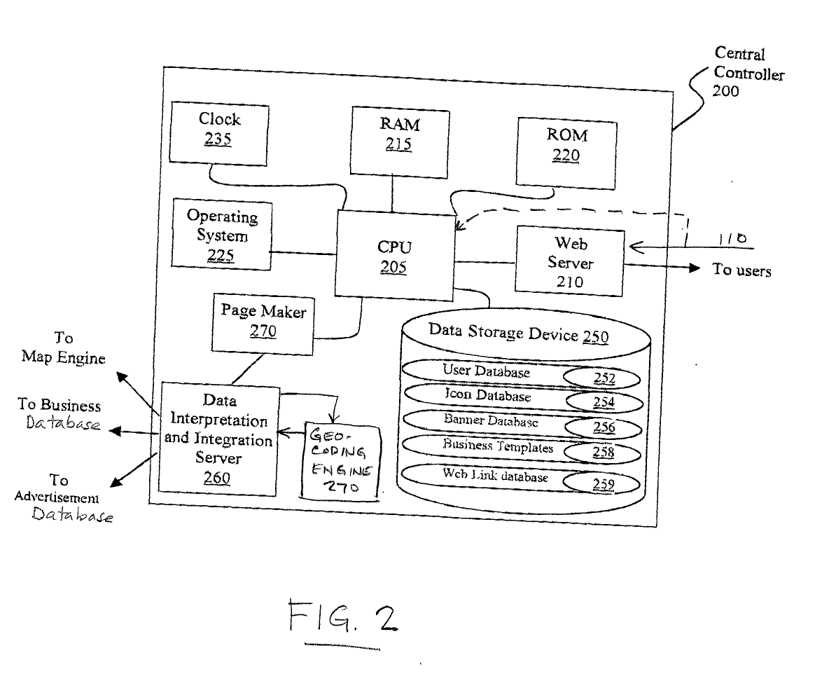

As shown in FIG. 2, the central controller 200 includes central processor (CPU) 205, RAM 215, ROM 220, a clock 235, an operating system 225, a DIIS 260, a geocoding engine 270 and a data storage device 250 of some kind.

A conventional personal computer or workstation with sufficient memory and processing capability may be used as a central controller 200. In one embodiment this personal computer also includes a web server 210, both receiving and transmitting CLRs 110 generated by users.

Referring again to FIG. 2, the data storage device 250 may be a hard disk (magnetic or optical), as well as a CD-ROM or flash memory. The data storage device contains databases used in the processing of transactions and web page constructions in the present invention, including a user database 252, a business icon database 254, a banner database 256, a business templates database 258, and web link database 259.

The user database 252 maintains log-in data on users with fields such as name, address, phone number, ID number, electronic mail address, past system usage etc. This information is obtained when the user first registers with the system, or immediately prior to posting his first CLR 110. This collection of data is optional.

The business icon database 254 contains graphic icons that are associated with each business type. For example, a fast food restaurant can be represented by an icon of a hamburger while a Chinese restaurant is represented by a pair of chop sticks over a bowl of noodles. The icons are linked to businesses via their unique IDs. In addition to assigning generic icons representative only of the type of business (restaurant vs. bookstore vs. grocery market), the trademarked icon of any business may be associated with it as well.

The advertisement banner database 256 contains graphic banners that are also associated with their corresponding businesses via unique IDs.

The business templates database 258 stores simple and pre-constructed web pages that are designed to help small business develop an online presence if they do not already have one. If a business does have a web page already, then instead of a user being taken to the business template web page, he will be taken to that business's pre-existing web page. These links are associated with the same unique ID as that business's advertisements and banners. In a similar embodiment, it is also possible to have a database that is dedicated to nothing but management of links on web pages as at 259.

The DIIS 260 contains programs that first send the address to the geocoding engine 270, which returns as X,Y part of geographic coordinates of that address. These programs then distribute more specific requests to the map engine, the business database, and the advertisement database. The DIIS is also responsible for combining the map and business information to yield the final result.

In another preferred embodiment, the user interface may be configured as a voice mail interface, electronic mail service, wireless phone entry site, or any other service capable of interacting with a user in a basic query-response environment.

While the above embodiment describes a bundle of computers acting as a central controller 200, a map engine 300, a business database 400 and an advertising database 500, those skilled in the art will realize that this bundle of computers can be scaled to incorporate a distributed architecture, wherein each processor and/or database is housed in separate units or locations. Those skilled in the art will realize that they can also use a different combination of the central controller and databases, for example, to form different configurations to meet different specific purposes. Those skilled in the art will appreciate that an almost unlimited number of bundles and combinations may be supported. This arrangement yields the possibility of a more dynamic and flexible system, extremely scalable, and less prone to catastrophic hardware failures that would affect the entire system, if integrated.

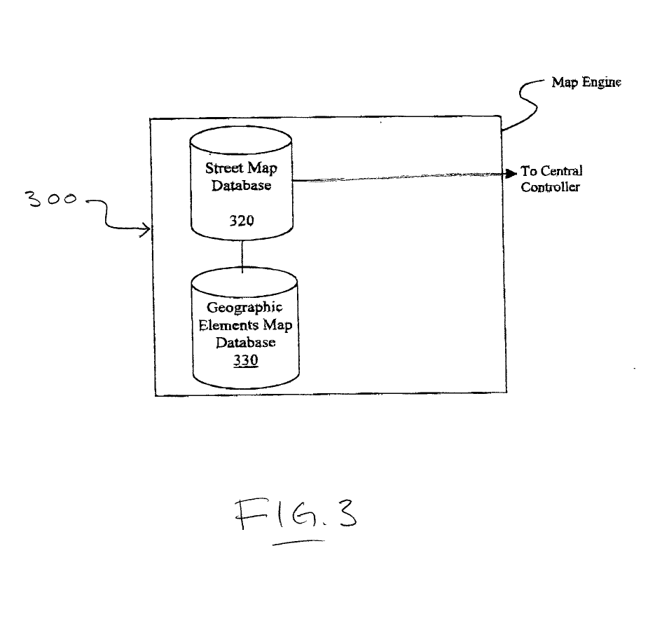

FIGS. 3, 4, and 5 describe the map engine 300, business database 400, and advertisement database 500, respectively. In an exemplary embodiment they are all conventional servers with storage devices, sufficient memory, a CPU, and a network connection. These devices interface with central controller 200.

Referring now to FIG. 3, the map engine 300, a computer with sufficient storage space and memory and a CPU, contains a map database, in this case a street map database 320 and a geographic elements database 330. Each of these could be commercially available products, such as Environmental Systems Research Institute's RouteMap Internet Map Server. They could also be the digital construction of a user's previously existing map engines, such as paper maps, that have been scanned into a computer with latitude and longitudinal values subsequently assigned. The map engine can also be a commercial Internet map engine, such as MapQuest.Com. Inc.'s MapQuest product.

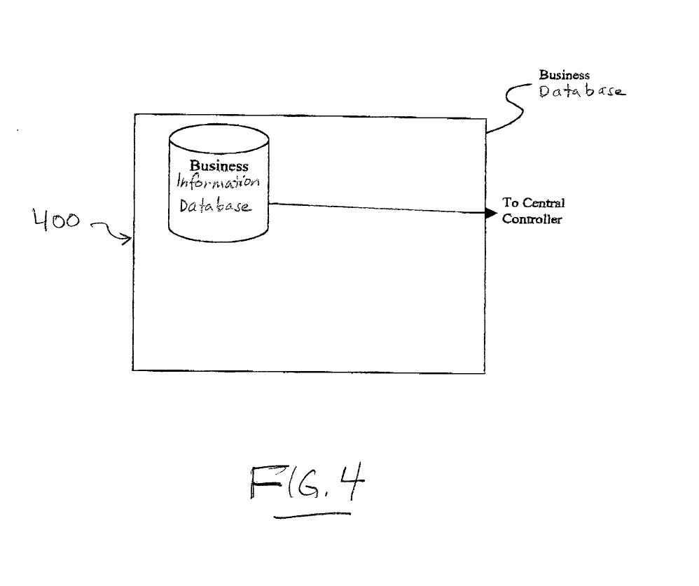

Referring to FIG. 4, the business database 400, a computer with sufficient storage space and memory and a CPU, contains a business information database 430. Similar to the above mentioned elements in FIG. 3, all of these elements could be commercially available products. In one exemplary embodiment, the business information could be commercially available data from InfoUSA Inc., which contains basic information on about 14 million businesses of the United States and can be managed in Oracle or MS SQL Server. The current invention pre-geocodes the business information database 430 using the geocoding engine 270 so that the database contains geographic coordinates for each business. Such a spatial business database enables business locating and searching with an accuracy to “air distance” or radius distance from a point. The database also contains unique IDs that are used to link businesses to their corresponding graphic icons.

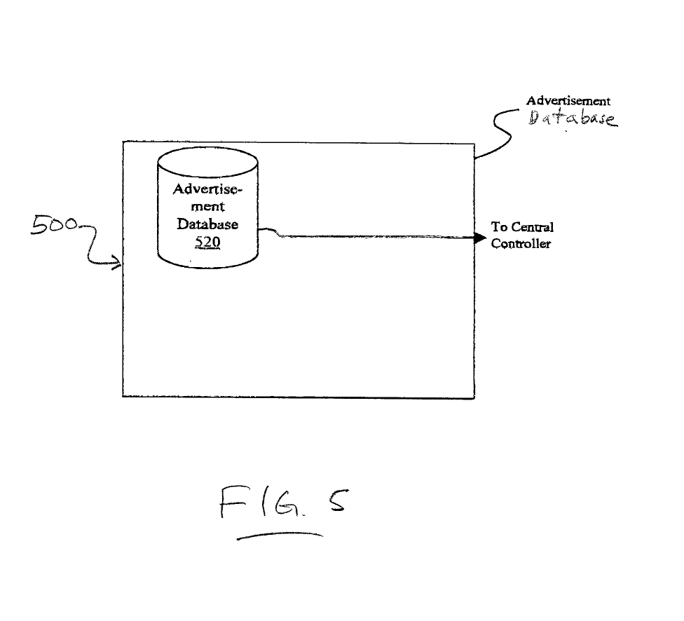

FIG. 5 illustrates components of the advertisement database. It contains an advertisement database 520. Advertisement records contain geographic coordinates of each business's corresponding business location. Such a spatial advertisement database enables geo-targeted advertising. Each advertisement record also contains a unique ID which is used to link it to a graphic symbol, such as a banner or dynamic GIF animation, etc., stored in the advertisement database.

Online Embodiment

In an online embodiment of the present invention, as seen in FIG. 1, communication between users and the system takes place via a wired or wireless network, with the central controller 200 acting as a server. The user sends a conditional locating request (CLR) 110 to the central controller 200. The CLR 100 is transmitted to the DIIS 260 (FIG. 2), which in turn interprets and distributes it to the map engine 300, business database 400, and advertisement database 500.

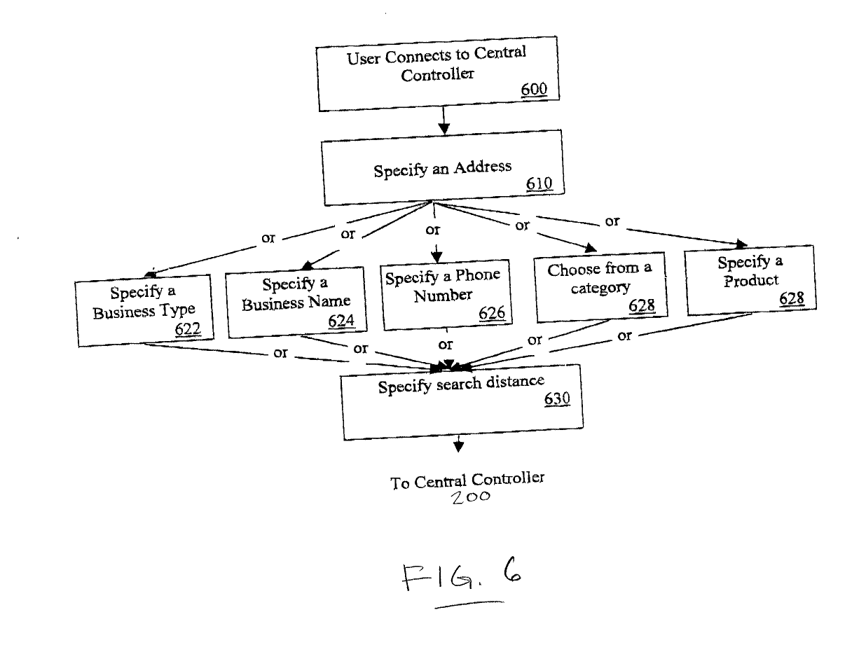

FIG. 6 describes the process by which the user can formulate a CLR. At step 600, the user connects to the central controller 200 via a wired or wireless network, which can be the Internet. It should be noted that the user might be an individual, an application program interface (API), a link from corporation web site, a partner's web site, a government web site, or any other entity, real or virtual. In one embodiment, the central controller 200 has a page on the World Wide Web, allowing the user to provide information through the interface of a conventional web browser. At step 610, the user specifies the address around which he wants to locate a business. In one embodiment, the address is a street address (street number, city, and state), or a city, or just a zip code. There are several ways to specify what kind of business to locate. As shown in boxes 622 through 628, the user might specify a business by its type, such as an Italian restaurant or Chinese restaurant. The user can type in a specific business name as in box 624, or a phone number as in box 626. The user can also choose a business type from a list of popular categories in box 628. In addition, user can simply input a product name for which a local business carrying the product is sought. For example, a user can choose the product dialog box 628 and type in “watch battery.” A search distance can be specified in box 630. In one embodiment, the default search distance is set to 0.5 miles. User has a choice of either accepting this default distance or specifies his own search distance. In one embodiment, a distance of miles could be used. A complete origin address, business type or product (or other specification as above), and search distance form the conditional locating request of CLR 110.

For example, a tourist in San Francisco might want to find a place for lunch in the financial district. He can use his web enabled cellular phone to enter the street address where he is located. He enters 300 Market Street, San Francisco, Calif. He then specifies an Italian restaurant. He accepts the default search distance of 0.5 miles. Once the above elements have been developed, the user transmits them to the central controller 200. The user does this by clicking on a “send” button seen on his cellular phone screen.

Instead of a cellular phone, users may also transmit the CLR 110 via the Internet or voice mail. With voice mail, the user calls central controller 200 and leaves his CLR 110 in audio form. The CLR 110 may be transcribed into digital text via an optional element in the central controller 200 (not herein described).

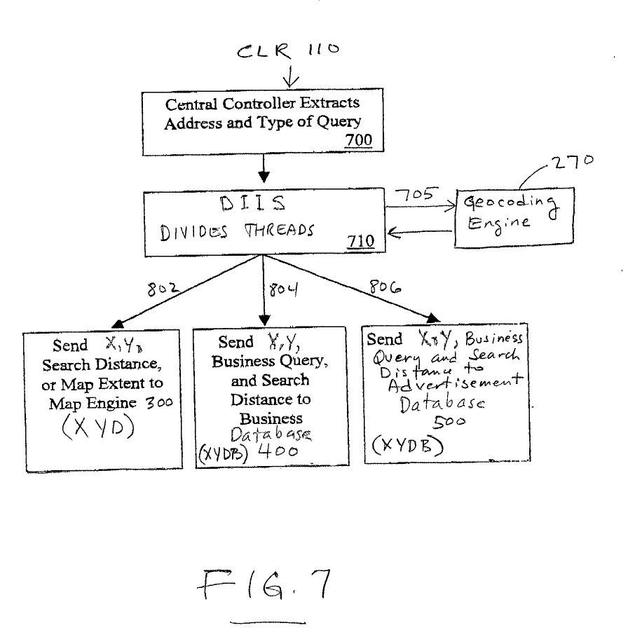

Referring now to FIG. 7, the CLR 110 is received and is checked to see if sufficient information is available. At step 700, the central controller 200 extracts an origin address, a business type, and a search distance from the CLR 110. At step 705, the DIIS sends the address to geocoding engine 270, which converts the address to X,Y geographic coordinates and send them back to the DIIS. At step 710, the DIIS generates three messages: X,Y coordinates and distance (XYD) 802, X,Y coordinates, distance, and business type (XYDB)804, and X,Y coordinates and business type, and search distance (XYDB) (806). At step 802, the data interpretation and integration server submits the XYD to the map engine 300. At step 804, it submits the XYDB to the business database 400. And at step 806, it submits the XYDB to the advertisement database 500. Steps 802 to 806 occur substantially simultaneously.

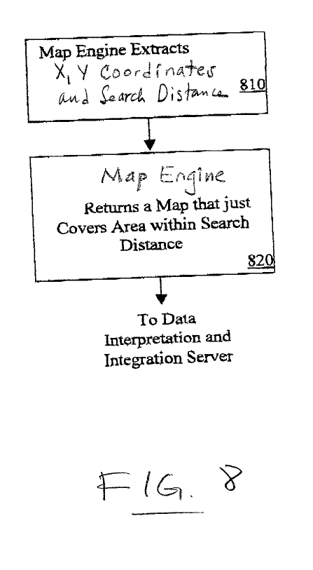

FIG. 8 illustrates an embodiment in which the XYD is transmitted to the map engine and a local map is extracted. At step 810, X,Y coordinates and distance information (XYD) are transmitted to the map engine 300. At step 820, the map engine uses these coordinates as the map center to extract a local a map containing streets, parks, waters, lakes, hospitals, and other geographic elements. The extracted map covers a rectangular area with at least two of its edges tangent with the circle of specified distance that is the search distance either specified by the user, or the default distance of 0.5 mile. The result is a map image that could be stored in commonly used format like JPEG, GIF, PNG, etc.

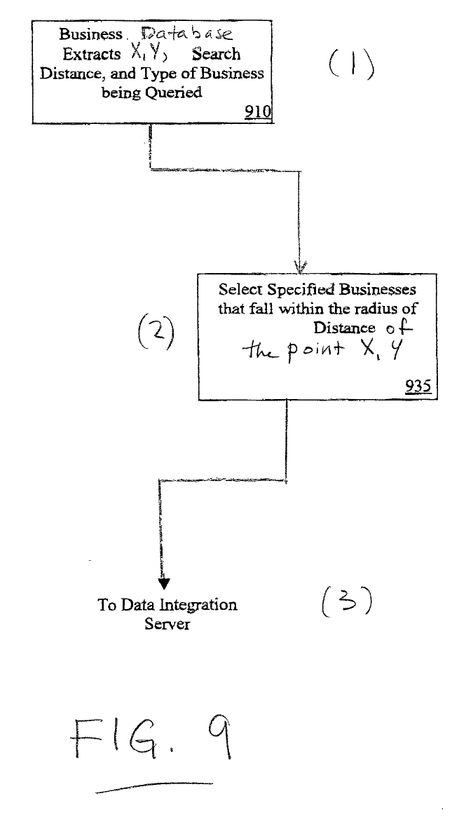

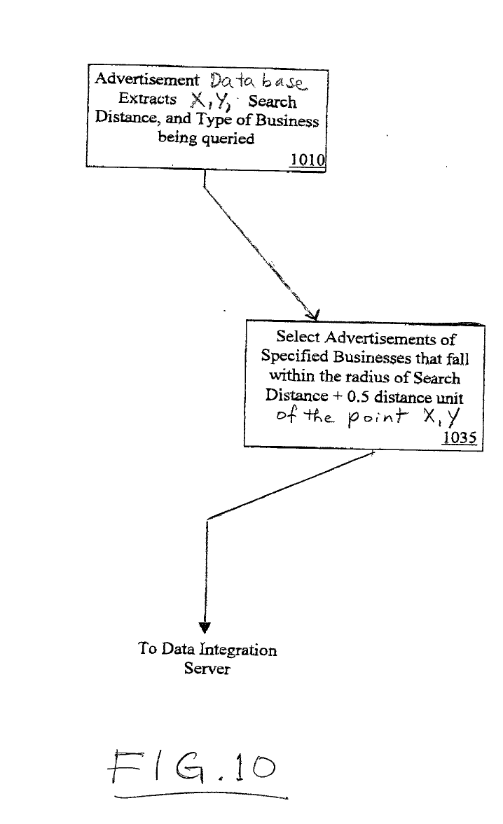

FIGS. 9 and 10 illustrate the process by which businesses and advertisements are located. The mechanisms and processes are similar between business query and advertisement query with only the search distance being different. At steps 910 and 1010, the X,Y coordinates, business type, and search distance are extracted and transmitted to databases. The distance is longer for the advertisement search than the business search so that more businesses get a chance to be exposed to potential customers. The length of the extra distance for the advertisement search is determined automatically and in one embodiment is set to 0.5 mile beyond the user's query, or e.g., two times the query radius. At steps 935 and 1035, business and advertisement data are selected, using SQL, based on the center point and search distance. The result of selected businesses is a list of business IDs that is sent to DIIS.

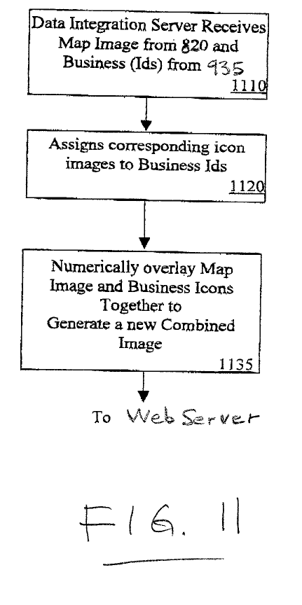

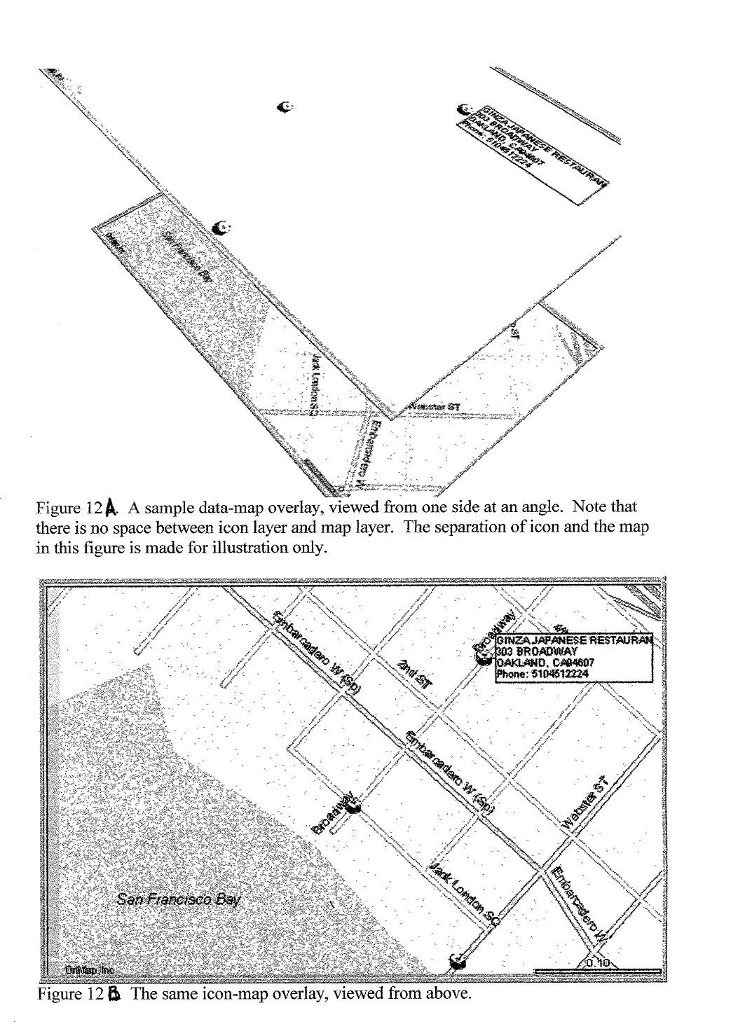

Referring now to FIG. 11, the data interpretation and integration server (DIIS) 260 overlays business icons on top of the map image to generate a combined image of businesses on a local map. In step 1110, the DIIS 260 receives a map image from step 820 and passes on the business IDs from step 935 to the business icon database 254. Particular business icons are then linked to those business IDs based on pre-defined matching roles, in step 1120. The business icons are then overlaid with the map image in step 1135 to generate a map of a street (with other geographic elements) and businesses. Such a map can be a commonly used image format that can be included in a web page if desired. For example, FIGS. 12A and 12B illustrate an online embodiment of such a business map using web pages. In this example, a Japanese restaurant is represented by an icon of a sushi image.

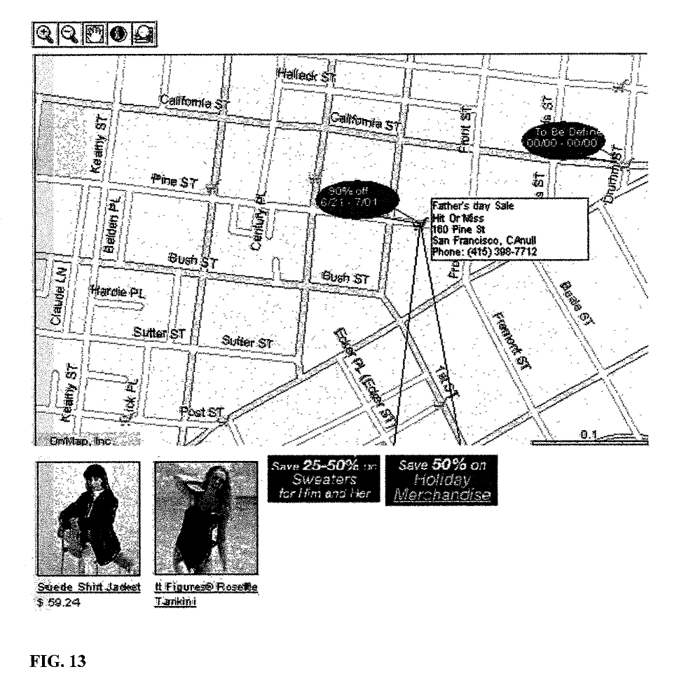

Advertisements found near an address can be used to compile web pages, display the data on WAP capable phones, or speak the results via telephones. In one embodiment, business banners are transmitted to users via the Internet. FIG. 13 illustrates an online embodiment in which advertisement banners of apparel stores in a selected area of San Francisco, Calif.

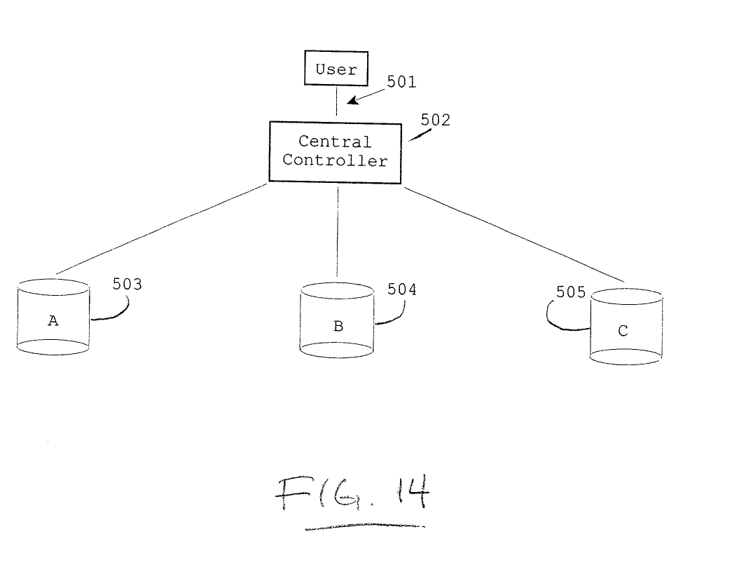

FIG. 14 is a block diagram showing the basic operation of the integration system. In this diagram the central controller is connected to three different databases (A, B, and C) which can be in different locations, even different parts of the country or world. This block diagram is useful for explaining the parallel nature of the processing allowed by this innovation.

When a query is made by a user 500, via the Internet or any other wired or wireless network, as indicated by the line 501 to the central controller 502, the central controller responds by sending inquiries to each of the databases A, B, and C, substantially simultaneously via multiple threads. As noted above, these databases might be a map or satellite image database, a database with information on businesses, and a database with advertising which can selectively be applicable to the various businesses or geographic locations using unique IDs. The central controller sends out three inquiries, in this example, and the various databases respond by matching any data fields to the inquiry to provide the matching data and sending that data back to the central controller substantially in real time. Because each database is separate and distinct from every other database, and because the request is sent via multiple threads, each database is free to process its respective inquiry and return a result as soon as one is found. Therefore, there is no delay imposed on each database by the searching of another which is necessarily the result when multiple databases process in serial, rather than in parallel as herein described. Each one of these answered queries (if an answer can be found) from the various databases may be in a different format such as Oracle, SQL, or the format used by MapQuest to store geographic information.

Instead of converting the individually-formatted answers from each database to a proprietary format as in the prior art, the central controller 502 of the invention is able to understand the various incoming formats and interpret the data in accordance with those formats as necessary in transferring the data accurately onto a map or photogeographic image. The term “map” as used herein is intended to include photogeographic images or geographic images other than those conventionally considered maps.

Regardless of the number or type of databases that are queried by the central controller, the applet will combine all given answers in multiple layers. The map geographic information is always level one. Any other information derived from a user's query is placed on top of the map. The presented image is viewed by the user as if from above so all incorporated information appears as a unified image.

The above described preferred embodiments are intended to illustrate the principles of the invention, but not to limit its scope. Other embodiments and variations to this preferred embodiment will be apparent to those skilled in the art and may be made without departing from the spirit and scope of the invention as defined in the following claims.

What is claimed is:

1. A method for integrating map data representing a geographic image with location-relevant information data in real time via communication devices to provide, from said information data, specific information identifying, describing, or otherwise relating to specific locations on the geographic image, and displaying the selected information relating to such locations directly on the geographic image, and for interacting and managing of the data relating to such locations directly on the geographic image, comprising,
providing a central controller and at least two separate databases, including a database containing map data and another database containing location-relevant information data,
accepting a request from a user for information concerning one or more locations on a geographic image and parsing that request via the central controller into multiple request threads and sending the threads to the databases concerned,
returning from each database to the central controller a response conforming to the user request, if available, and, with the central controller, combining the responses from each database into a combined image, and
displaying the combined image for the user.

2. The method of claim 1, wherein the central controller also acts as a web server, accepting from a user requests sent via the Internet, LAN or wireless connections.

3. The method of claim 2, wherein the databases are stored at geographically separate locations.

4. The method of claim 3, wherein communication between the central controller and at least one of the databases is via Internet, LAN or wireless connection.

5. The method of claim 1, wherein the databases are stored on a single data storage device rather than a plurality of computers.

6. The method of claim 1, including at least two separate databases having location-relevant information data.

7. The method of claim 1, wherein the databases are stored at geographically separate locations.

8. The method of claim 1, wherein at least one of the databases is at a geographically separate location from the central controller, and wherein the sending and returning steps for said one database are via Internet, LAN or wireless connection.

9. The method of claim 1, wherein the databases include a business database, containing information on a multiplicity of business and their locations.

10. The method of claim 9, wherein the databases further include an advertisement database having location-relevant advertising information for at least some of the businesses in the business database.

11. The method of claim 1, wherein the request from the user includes a certain geographic point and a radius distance from that point, within which information is requested by the user, and including the central controller's limiting the request threads to such point and radius.
